(19) United States
(12) Patent Application Publication
(10) Pub. No.: US 2024/0407444 A1
(43) Pub. Date: Dec. 12, 2024

(54) DEVICE FOR GENERATING AEROSOL AND MANUFACTURING METHOD WITH THE SAME

(71) Applicant: KT&G CORPORATION, Daejeon (KR)

(72) Inventor: Hwikyeong AN, Seoul (KR)

(73) Assignee: KT&G CORPORATION, Daejeon (KR)

(21) Appl. No.: 18/699,480

(22) PCT Filed: Oct. 12, 2022
(86) PCT No.: PCT/KR2022/015420

§ 371 Date: Apr. 8, 2024

(30) Foreign Application Priority Data
Oct. 28, 2021 (KR) 10-2021-0146102

(51) Int. Cl. A24F 40/46; A24F 40/485; A24F 40/70

(52) U.S. Cl. CPC A24F 40/46; A24F 40/485; A24F 40/70

(57) ABSTRACT

An aerosol-generating device is disclosed. the aerosol-generating device may include an elongated heater pin; a flange protruding laterally from one side of the heater pin; a pipe shaped to define an insertion space; and a cover blocking one side of the insertion space and coupled to the flange such that the heater pin is protruded to the insertion space, wherein the flange is coupled to engage with the cover and includes a surface that is exposed to the insertion space.

### TECHNICAL FIELD

The present disclosure relates to an aerosol-generating device and a method for manufacturing an aerosol-generating device.

### BACKGROUND ART

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol-generating devices has been conducted.

### DISCLOSURE

### Technical Problem

It is an object of the present disclosure to solve the above and other problems.

It is another object of the present disclosure to provide an aerosol-generating device having a structure that can prevent the injection product from being harden on the outside surface of the heater pin disposed in the insertion space.

It is another object of the present disclosure to provide an aerosol-generating device capable of improving the thermal conductivity efficiency of the heater and the reliability of the thermal conductivity.

It is another object of the present disclosure to provide an aerosol-generating device capable of preventing the heater pin from being separated from the device or the heater pin being broken.

It is another object of the present disclosure to provide a method for manufacturing the aerosol-generating device.

### Technical Solution

According to one aspect of the present disclosure for achieving the above object, The aerosol-generating device includes an elongated heater pin; a flange protruding laterally from one side of the heater pin; a pipe shaped to define an insertion space; and a cover blocking one side of the insertion space and coupled to the flange such that the heater pin is protruded to the insertion space, wherein the flange is coupled to engage with the cover and includes a surface that is exposed to the insertion space.

### Advantageous Effects

According to at least one of the embodiments of the present disclosure, it is possible to be provided an aerosol-generating device having a structure that can prevent the injection product from being hardened on the outside of the heater pin disposed in the insertion space.

According to at least one of the embodiments of the present disclosure, it is possible to be provided an aerosol-generating device capable of improving the thermal conductivity efficiency and reliability of the thermal conductivity of the heater.

According to at least one of the embodiments of the present disclosure, it is possible to be provided an aerosol-generating device capable of preventing the heater pin from being separated from the device or the heater pin from being broken.

According to at least one of the embodiments of the present disclosure, it is possible to be provided a method for manufacturing the aerosol-generating device.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### DESCRIPTION OF DRAWINGS

The above and other objects, features, and other advantages of the present disclosure will be more clearly understood from the following detailed description taken in conjunction with the accompanying drawings, in which:

FIGS. 1 to 28 are views showing examples of an aerosol-generating device according to embodiments of the present disclosure.

### MODE FOR INVENTION

Hereinafter, the embodiments disclosed in the present specification will be described in detail with reference to the accompanying drawings, and the same or similar elements are denoted by the same reference numerals even though they are depicted in different drawings, and redundant descriptions thereof will be omitted.

In the following description, with respect to constituent elements used in the following description, the suffixes “module” and “unit” are used only in consideration of facilitation of description, and do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

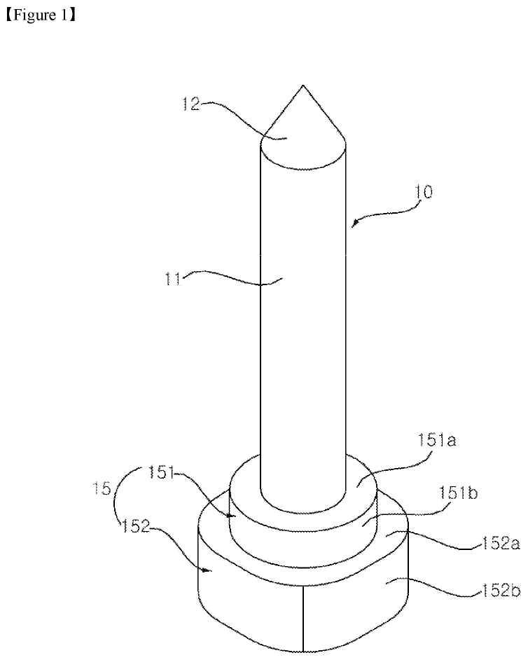

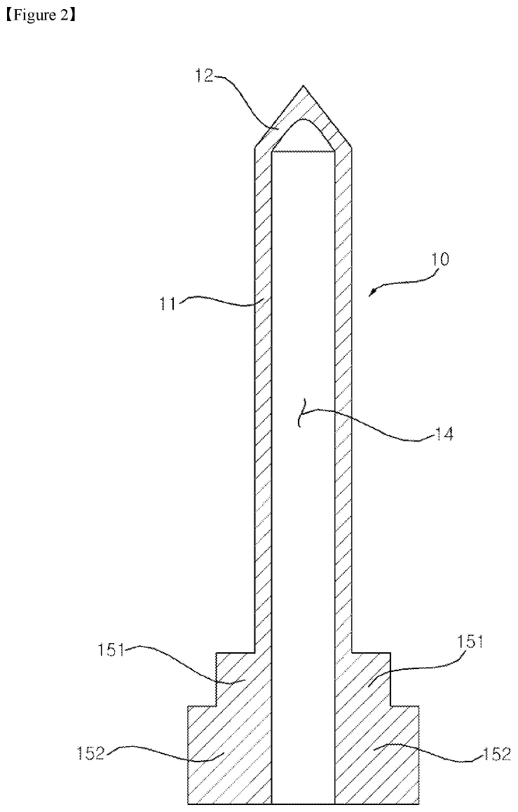

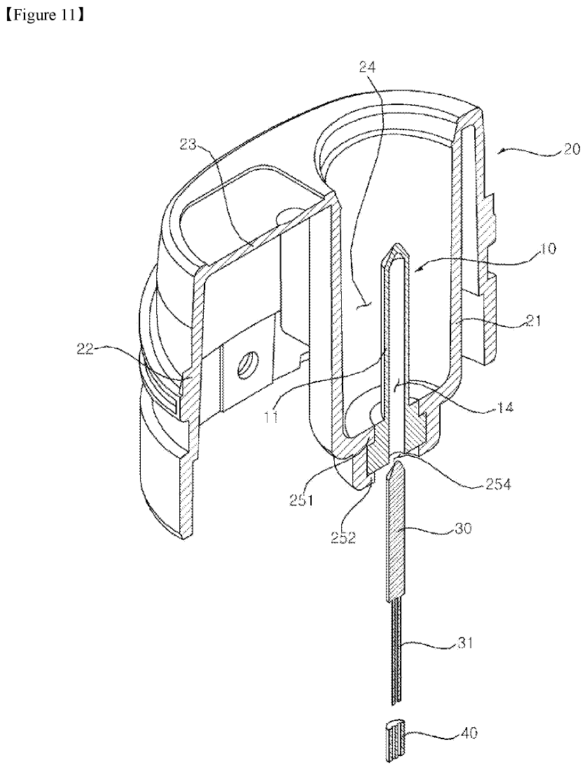

Referring to FIG. 1 and FIG. 2, the heater pin 10 may extend vertically. The heater pin 10 may have a cylindrical shape. The upper end of the heater pin 10 may be sharply formed. The heater pin 10 may provide a space into which the heater 30 (refer to FIG. 11) can be inserted. The heater pin 10 may be made of a ceramic material.

The heater pin 10 may include a pin body 11. The pin body 11 may extend long in the vertical direction. The pin body 11 may have a cylindrical shape. The pin body 11 may be formed as a hollow 14 inside. A lower portion of the heater pin 10 may be opened to communicate with the hollow 14. The hollow 14 may extend vertically up and down.

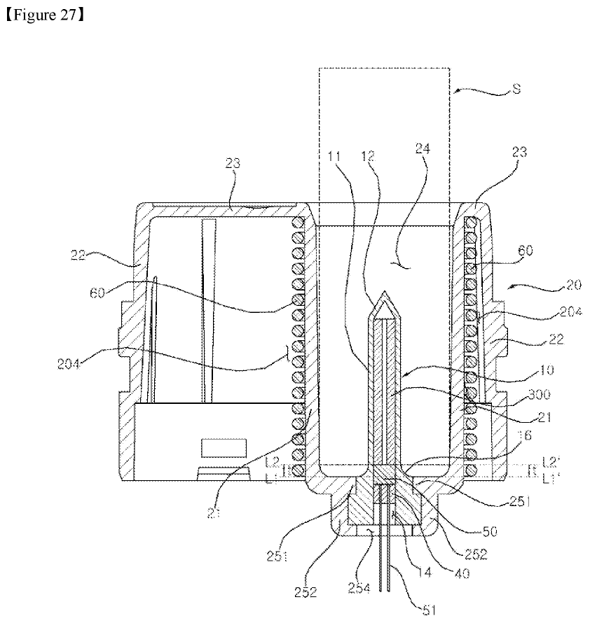

The heater pin 10 may include a pin tip 12. The pin tip 12 may form an upper end of the heater pin 10. The pin tip 12 may be formed integrally with the pin body 11 on the upper portion of the pin body 11. The pin tip 12 may have a shape gradually narrowing toward the upper side. The top of the pin tip 12 may be pointed. Accordingly, the heater pin 10 may penetrate the stick S (refer to FIG. 27) to fix the stick S.

The flange 15 may protrude outward from the heater pin 10. The flange 15 may protrude laterally from the lower end of the heater pin 10. The flange 15 may protrude radially outward from the heater pin 10. The flange 15 may be integrally formed with the heater pin 10.

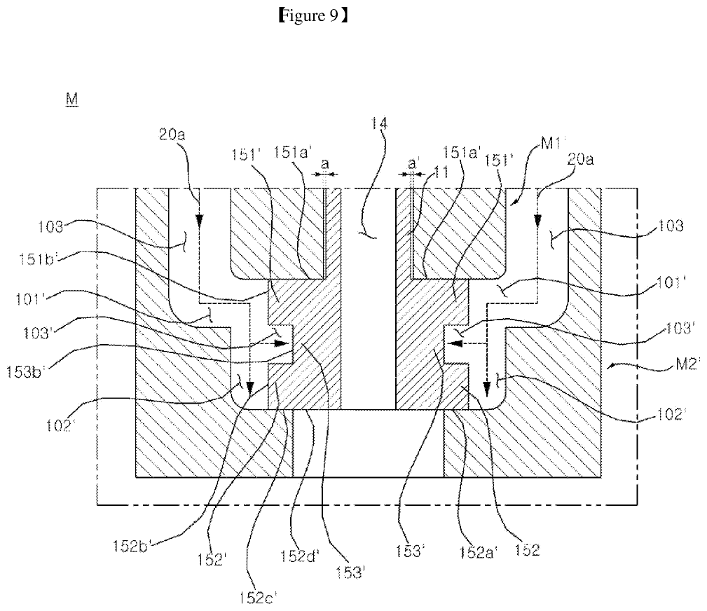

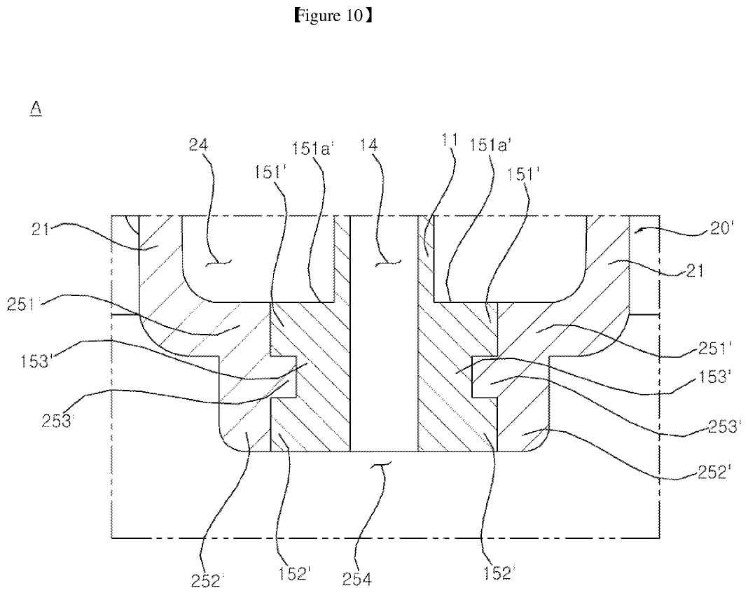

The flange 15 may be formed in a plurality of steps. For example, the flange 15 may be formed in two steps. For example, the flange 15 may include a first flange 151 and a second flange 152. The first flange 151 may be positioned on the upper portion of the flange 15. The second flange 152 may be positioned on the lower portion of the flange 15. Hereinafter, the flange 15 including the first flange 151 and the second flange 152 will be described, but the present invention is not limited thereto, and the flange 15 may include a larger number of flanges. For example, the flange 15 may be formed in three or more steps (see FIGS. 9 and 10).

The first flange 151 may be disposed above the second flange 152. The first flange 151 may be integrally formed with the second flange 152. The first flange 151 may be disposed on the lower portion of the pin body 11. The first flange 151 may protrude from the outer circumferential surface of the pin body 11 in an outer lateral direction or a radially outward direction. The first flange 151 may extend in a circumferential direction.

The second flange 152 may be disposed below the first flange 151. The second flange 152 may be disposed at the lower end of the heater pin 10. The second flange 152 may protrude from the outer circumferential surface of the pin body 11 in the outer lateral direction or radially outward direction. The second flange 152 may protrude more in an outer lateral direction or a radially outward direction than the first flange 151.

Accordingly, there may be a step difference between the first flange 151 and the second flange 152.

At least one of the first flange 151 and the second flange 152 may have a non-circular cross-section. For example, the first flange 151 may extend in the circumferential direction to have a circular cross-sectional shape, and the second flange 152 may have a non-circular cross-sectional shape.

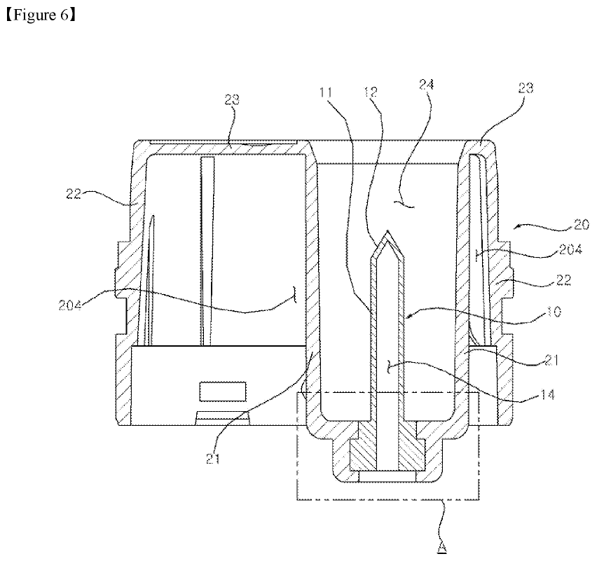

Accordingly, for example, when inserting/removing the stick S and cleaning the heater pin 10, the heater pin 10 coupled to the pipe 21 (refer to FIG. 6) may be prevented from rotating from the body.

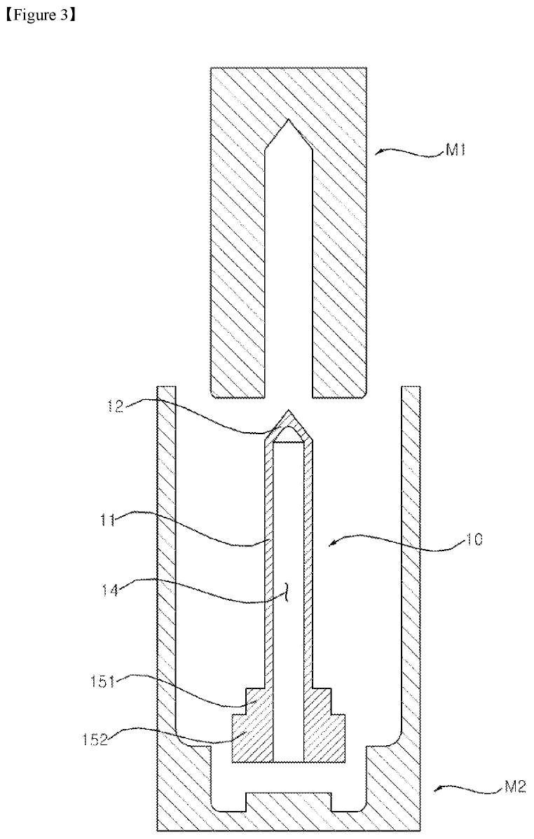

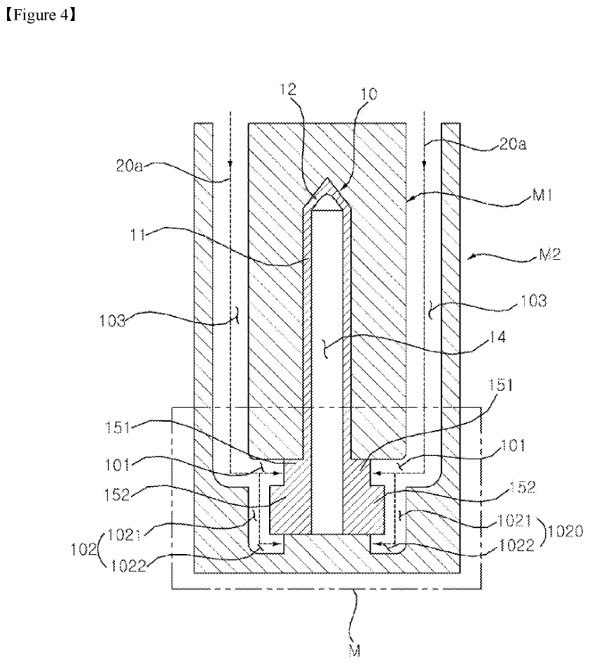

Referring to FIG. 3 and FIG. 4, the heater pin 10 and the flange 15 may be inserted into the mold. An upper portion of the heater pin 10 may be inserted into the first mold M1. A lower portion of the heater pin 10 may be inserted into the second mold M2. The first mold M1 and the second mold M2 are vertically coupled to each other to provide a space in which the heater pin 10 and the flange 15 can be disposed. The first mold M1 and the second mold M2 may be spaced apart from each other, and passages 101, 102, 103 may be formed therebetween.

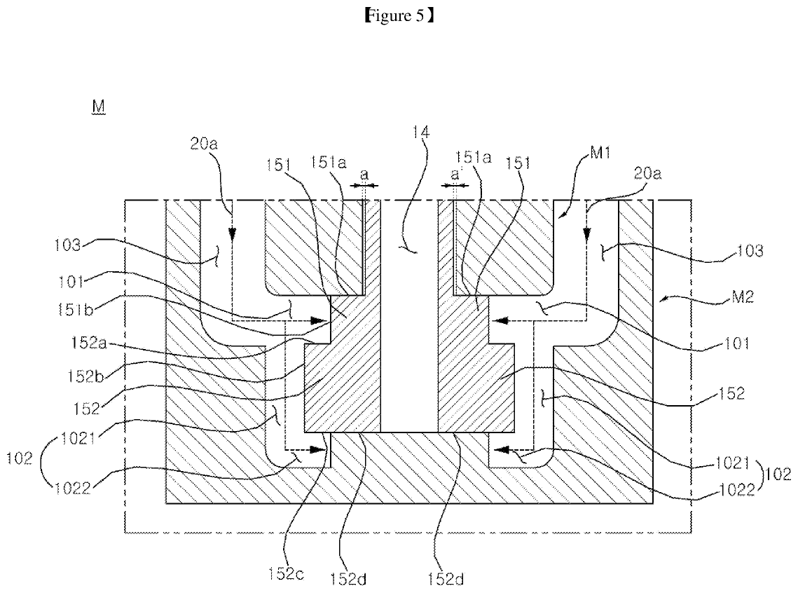

Referring to FIG. 4 and FIG. 5, the pin body 11 and the pin tip 12 may be inserted into the groove formed in the first mold M1. The first mold M1 may be in close contact with the first flange 151. The second mold M2 may be in close contact with the inner lower surface 152b of the second flange 152. The second mold M2 and the first mold M1 may be spaced apart from each other to form passages 101, 102, 103 therebetween. The first passage 101 and the second passage 102 may surround the flange 15.

The pipe passage 103 may extend in the vertical direction. The pipe passage 103 may be formed in a cylindrical shape. The pipe passage 103 may surround the periphery of the lateral side of the pin body 11 and the pin tip 12.

The first passage 101 may be connected to the pipe passage 103. The first passage 101 may be formed to extend from the lower end of the pipe passage 103 in an inward lateral direction or in a radially inward direction. The first passage 101 may surround or cover the lateral surface 151b of the first flange 151. The first passage 101 may extend along the circumference of the lateral surface 151b of the first flange 151. The first passage 101 may cover the upper surface 152a of the second flange 152.

The second passage 102 may communicate with the first passage 101. The second passage 102 may extend downward from the first passage 101. The lateral portion 1021 of the second passage 102 may surround the lateral surface 152b of the second flange 152. The lower portion 1022 of the second passage 102 may cover the outer lower portion 152c of the second flange 152. The second passage 102 may extend along a circumference of the second flange 152.

The injection-molding material 20a in a molten state may be injected into the passages 101, 102, 103 between the first mold M1 and the second mold M2. The injection-molding material 20a may fill the passages 101, 102, 103. The injection-molding material 20a may be harden to form a body 20 (refer to FIG. 6).

The first mold M1 may be in close contact with the upper surface 151a of the first flange 151. A gap communicating with the first passage 101 may not be formed between the first mold M1 and the upper surface 151a of the first flange 151.

Accordingly, the injection-molding material 20a may not flow between the first mold M1 and the upper surface 151a of the first flange 151. In addition, even if there is a play a, a′ between the first mold M1 and the pin body 11 in order to insert the pin body 11 into the groove of the first mold M1, the first mold M1 and the first flange 151 are in close contact with each other, the injection product 20a may not flow between the first mold M1 and the pin body 11.

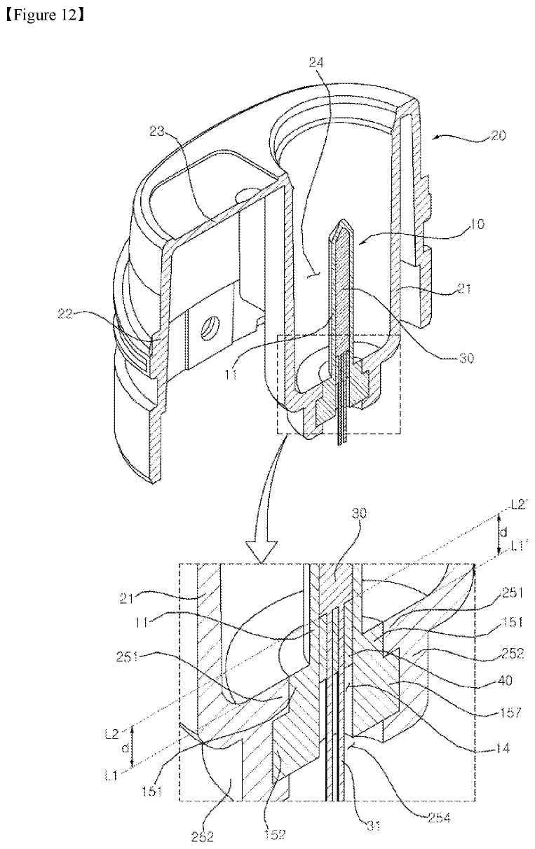

In addition, since the injection-molding material 20a is not hardened after being injected to the outside of the pin body 11, the heat conduction efficiency of the heater 30 (refer to FIGS. 12 and 27) is increased, and the reliability of the heat conductivity may be secured.

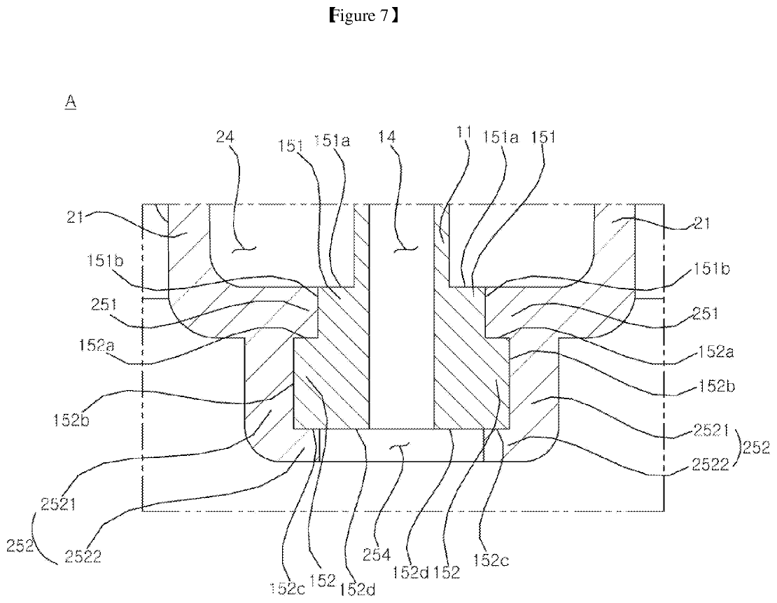

Referring to FIG. 4 to FIG. 7, the body 20 may include a pipe 21. The body 20 may include cover 251, 252. The cover 251, 252 may include a first cover portion 251. The cover 251,252 may include a second cover portion 252. The injection-molding material 20a filling the passages 101, 102, 103 may be harden to form the body 20. The injection-molding material 20a filling the pipe passage 103 may be harden to form the pipe 21. The injection-molding material 20a filling the first passage 101 may be harden to form the first cover portion 251. The injection-molding material 20a filling the second passage 102 may be harden to form the second cover portion 252. The cover 251, 252 may be engaged with the flanges 151, 152.

The pipe 21 may extend long in the vertical direction. The pipe 21 may be formed in a hollow cylindrical shape. The pipe 21 may provide an insertion space 24 having an open upper side. The pipe 21 may cover the lateral side of the insertion space 24. The insertion space 24 may be surrounded by the inner circumferential surface of the pipe 21. The cover portion 251, 252 may block the lower portion of the insertion space 24 and form a bottom. The upper end of the insertion space 24 is open, and the lower end may be covered by the first cover portion 251 and the first flange 151. The heater pin 10 may be disposed in the insertion space 24. The heater pin 10 may be disposed to be elongated toward the opening of the insertion space 24.

The first cover portion 251 may be connected to the lower end of the pipe 21. The first cover portion 251 may protrude from the lower end of the pipe 21 in an inward lateral direction or a radially inward direction to extend. The first cover portion 251 may be in close contact with the lateral surface 151b of the first flange 151. The first cover portion 251 may not cover the upper surface 151a of the first flange 151. The first cover portion 251 may cover or be in close contact with the upper surface 152a of the second flange 152. The first cover portion 251 may cover the bottom of the insertion space 24.

The upper surface 151a of the first flange 151 may face the bottom of the insertion space 24. Since the first mold M1 and the upper surface 151a of the first flange 151 are in close contact with each other, a gap communicating with the first passage 101 is not formed, so the injection-molding material 20a may not flow between the first mold M1 and the upper surface 151a of the first flange 151. Accordingly, the upper surface 151a of the first flange 151 is not covered by the body 20, and may be exposed to the insertion space 24 or cover the bottom of the insertion space 24.

The second cover portion 252 may be connected to the first cover portion 251. The second cover portion 252 may protrude downward from the first cover portion 251 to extend. A lateral portion 2521 of the second cover portion 252 may extend downwardly from the first cover portion 251. The lower portion 2522 of the second cover portion 252 may protrude from the lower end of the lateral portion 2521 of the second cover portion 252 in an inward lateral direction or the radially inward direction to extend.

The second cover portion 252 may be in close contact with the lateral surface 152b and the outer lower portion 152c of the second flange 152. The lateral portion 2521 of the second cover portion 252 may be in close contact with the lateral portion 152b of the second flange 152. The lower portion 2522 of the second cover portion 252 may cover or be in close contact with the outer lower portion 152c of the second flange 152. The second flange 152 may be disposed between the first cover portion 251 and the second cover portion 252 and supported in the vertical direction.

The second cover portion 252 does not cover the inner lower portion 152d of the second flange 152, and a cover hole 254 may be formed inside the lower portion 2522 of the second cover portion 252. The cover hole 254 may communicate with the hollow 14 of the heater pin 10.

Accordingly, the injection-molding material 20a is not smeared on the outer circumferential surface of the pin body 11, heat conduction efficiency is increased, and reliability of heat conductivity can be secured. In addition, by sealing the space between the cover 251, 252 and the flanges 151, 152, it is possible to prevent foreign substances such as liquid from leaking to the lower side of the insertion space 24.

In addition, since the flanges 151, 152 are coupled to engage the cover 251, 252 and supported in the vertical direction, it is possible to prevent the heater pin 10 from being separated from the pipe 21, and structural stability is improved.

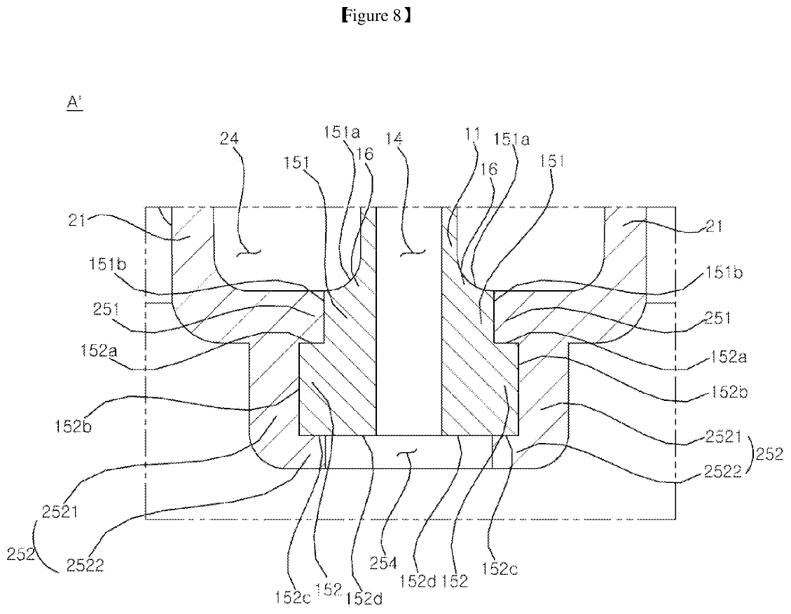

Referring to FIG. 8, the rib 16 may be formed between the pin body 11 and the upper surface 151a of the first flange 151. The rib 16 protrudes upwardly from the upper surface 151a of the first flange 151 and may extend obliquely upward toward the outer circumference surface of the pin body 11. The rib 16 may be integrally formed with the pin body 11 and the first flange 151. The rib 16 may extend in the circumferential direction along the outer circumferential surface of the pin body 11. Alternatively, a plurality of ribs 16 may be provided and arranged to be spaced apart from each other in the circumferential direction along the outer circumferential surface of the pin body 11.

Accordingly, the rib 16 can support the pin body 11 and can prevent the pin body 11 from being broken.

Referring to FIG. 9, the flange 15 may include a first flange 151′. Flange 15 may include a second flange 152′. The flange 15 may include a third flange 153′.

The first flange 151′ may be positioned above the flange 15. The second flange 152′ may be positioned under the flange 15. The third flange 153′ may be positioned between the first flange 151′ and the second flange 152′.

Between the first flange 151′ and the second flange 152′, the third flange 153′ may be depressed inwardly. The third flange 153′ may be referred to as a depression 153′.

The heater pin 10 may be inserted into the first mold M1′. The first mold M1′ may be in close contact with the upper surface 151a′ of the first flange 151′. A gap communicating with the first passage 101′ is not formed between the first mold M1′ and the upper surface 151a′ of the first flange 151′, so that the injection-molding material 20a may not flow in. The second mold M2′ may be spaced apart from the first mold M1′ to form passages 101′, 102′, 103′, 103 therebetween.

The first passage 101′ may communicate with the lower end of the pipe passage 103. The first passage 101′ may surround the lateral surface 151b′ of the first flange 151′. The second passage 102′ may surround the lateral surface 152b′ of the second flange 152′. The third passage 103′ may surround the lateral surface 153b′ of the third flange 153′. The third passage 103′ may be positioned between the first passage 101 ‘and the second passage 102’. The third passage 103′ may communicate with the first passage 101′ and the second passage 102′.

Referring to FIG. 9 and FIG. 10, the body 20′ may include a pipe 21. The body 20′ may include a first cover portion 251′. The body 20′ may include a second cover portion 252′. The body 20′ may include a third cover portion 253′. The injection-molding material 20a may be introduced into the passages 101′, 102′, 103′, 103 to be harden, thereby forming the body 20′.

The first cover portion 251′ may extend inwardly from the lower end of the pipe 21. The first cover portion 251′ may be closely coupled to the lateral surface 151b′ of the first flange 151′. The upper surface 151a′ of the first flange 151′ is not covered by the body 20′, and may be exposed to the insertion space 24. The upper surface 151a′ of the first flange 151′ may cover the lower portion of the insertion space 24 together with the first cover portion 251′.

The third cover portion 253′ may protrude more inward than the first cover portion 251′. The third cover portion 253′ may protrude more inward than the second cover portion 252′. The third cover portion 253′ may be in close contact with the lateral surface of the recessed portion 153′. The third cover portion 253′ may be referred to as a protrusion portion 253′.

The protrusion portion 253′ may be inserted in close contact with the depression portion 153′ between the first cover portion 251′ and the second cover portion 252′. The protrusion portion 253′ may be supported in close contact with the lower portion of the first cover portion 251′. The protrusion portion 253′ may be supported in close contact with the upper portion of the second cover portion 252′. The protrusion portion 253′ may be vertically supported by the first cover portion 251′ and the second cover portion 252′.

The first mold M1′ may be in close contact with the upper surface 151a′ of the first flange 151′. A gap communicating with the first passage 101′ may not be formed between the first mold M1′ and the upper surface 151a′ of the first flange 151′.

Accordingly, the injection-molding material 20a may not flow between the first mold M1′ and the upper surface 151a′ of the first flange 151′. In addition, even if there is a play a, a′ between the first mold M1′ and the pin body 11 in order to insert the pin body 11 into the groove of the first mold M1′, since the first mold M1′ and the first flange 151′ are in close contact with each other, the injection product 20a may not flow between the first mold M1′ and the pin body 11. In addition, since the injection product 20a is not hardened by being injected to the outside of the pin body 11, the heat conduction efficiency of the heater 30 (see FIGS. 12 and 27) is increased, and the reliability of the heat conduction efficiency can be secured.

In addition, by sealing the gap between the cover 251′, 252′, 253′ and the flanges 151′, 152′, 153′, it is possible to prevent foreign substances such as liquid from leaking to the lower side of the insertion space 24.

In addition, the flanges 151′, 152′, 153′ are coupled to engage the cover 251′, 252′, 253′ and are supported in the vertical direction, so that it is possible to prevent the heater pin 10 is separated from the pipe 21, and structural stability can be secured.

Referring to FIG. 11 and FIG. 12, the hollow 14 inside the pin body 11 is extended vertically and may be opened downwardly. The hollow 14 may communicate with the cover hole 254. The heater 30 may extend vertically. The heater 30 may be inserted and fixed into the hollow 14 through the cover hole 254. The heater 30 may be in close contact with the inner circumferential surface of the pin body 11 in the hollow 14.

The heater lead wire 31 may be connected to the heater 30. The heater lead wire 31 may be provided as a pair. The heater lead wire 31 may be exposed to the lower side of the pipe 21 and the cover 251, 252 through the cover hole 254. The heater lead wire 31 may receive power from a power supply source and transmit it to the heater 30. The heater 30 may be heated by receiving a current through the heater lead wire 31. The heater 30 may be heated to transfer heat to the outside of the heater pin 10. The heater 30 may heat the insertion space 24 or the stick (S, see FIG. 27) inserted into the insertion space 24. The heater pin 10 may have stronger heat resistance than the injection-molding material 20a or the body 20.

The heater 30 may be disposed above the bottom of the insertion space 24. The heater 30 may be disposed above the first cover portion 251. The heater 30 may be disposed above the first flange 151. The first line L1-L1′ may be defined as virtual line on the same plane as the bottom of the insertion space 24 or the top surface of the first cover portion 251. The second line L2-L2′ may be defined as virtual line parallel to the first line L1-L1′ and is on the same plane as the bottom of the heater 30. The second line L2-L2′ may be spaced upward from the first line L1-L1′ by a predetermined distance d. The predetermined distance d may be 0 mm or more.

The pin body 11 and the first flange 151 may be disposed between the heater 30 and the first cover portion 251. The first cover portion 251 may be spaced apart from the heater 30 by the pin body 11 and the first flange 151.

The reinforcing material 40 may be inserted and fixed into the hollow 14 of the heater pin 10 through the cover hole 254. The reinforcing material 40 may be disposed below the heater 30. The reinforcing material 40 may support the lower portion of the heater 30. The reinforcing material 40 may be fixed in close contact with the inner circumferential surface of the heater pin 10 in the hollow 14. The reinforcing material 40 may fill the hollow 14. The heater lead wire 31 may penetrate the hole of the reinforcing material 40 and be exposed to the outside of the heater pin 10. The rigidity of the reinforcing material 40 may be the same as that of the heater pin 10 or greater than that of the heater pin 10. The reinforcing material 40 may be made of a material having high heat resistance.

The reinforcing material 40 may overlap the upper surface 151a of the first flange 151. The reinforcing material 40 may extend vertically. The upper end of the reinforcing material 40 may be located at a height higher than the upper surface 151a of the first flange 151. The lower end of the reinforcing material 40 may be located at a height lower than the upper surface 151a of the first flange 151. The reinforcing material 40 may reinforce the rigidity of the pin body 11 around the upper surface 151a of the first flange 151 inside the upper surface 151a of the first flange 151.

Accordingly, the influence of the heat generated from the heater 30 on the first cover portion 251 may be reduced. In addition, it is possible to prevent the first cover portion 251 from being thermally deformed so that a gap is generated between the first cover portion 251 and the heater pin 10 or the gap is widened. In addition, it is possible to prevent foreign substances such as liquid from leaking through the gap.

In addition, the reinforcing material 40 may prevent the heater pin 10 from breaking around the first flange 151.

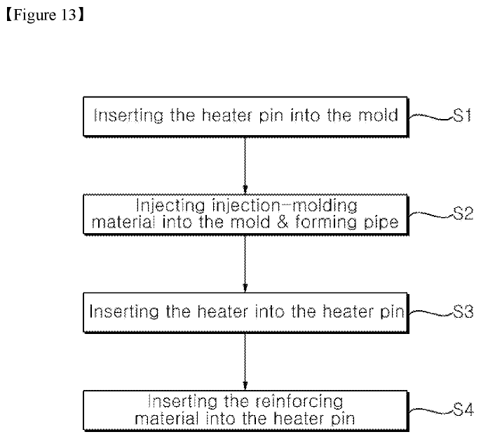

Referring to FIG. 13, the method for manufacturing an aerosol-generating device may include inserting the heater pin 10 into the molds M1, M2 (S1). In step S1, the first mold M1 and the upper surface 151a of the first flange 151 may be in close contact with each other. In step S1, a gap communicating with the first passage 101 may not be formed between the first mold M1 and the upper surface 151a of the first flange 151. Accordingly, the injection-molding material 20a may not flow from the first passage 101 between the first mold M1 and the pin body 11.

The aerosol-generating device manufacturing method may include the step (S2) of forming the pipe 21 by injecting the injection-molding material 20a into the passage formed in the molds M1, M2 (S2). The cover 251, 252 formed in step S2 may be coupled to engage the flanges 151, 152 to support the flanges 151, 152 in the vertical direction. In step S2, the cover hole 254 may be formed to communicate with the hollow of the heater pin 10.

The method for manufacturing an aerosol-generating device may include inserting the heater 30 into the heater pin 10 (S3). In step S3, the heater 30 may be inserted into the hollow 14 in the heater pin 10. In step S3, the heater 30 may be disposed higher than the upper surface 151a of the first flange 151. Accordingly, the influence of the heat generated from the heater 30 on the first cover portion 251 may be reduced.

The method for manufacturing an aerosol-generating device may include inserting the reinforcing material 40 into the heater pin 10 (S4). In step S4, the reinforcing material 40 may overlap and be fixed with the upper surface 151a of the first flange 151. In step S4, the reinforcing material 40 may reinforce the rigidity of the pin body 11 around the upper surface 151a of the first flange 151, inside the upper surface 151a of the first flange 151.

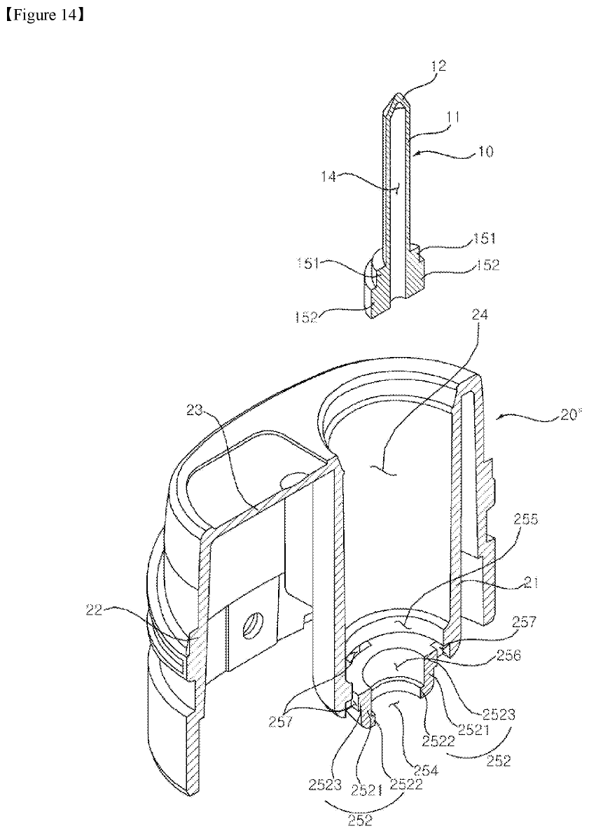

Referring to FIG. 14, the body 20″ may include a first space 255. The body 20″ may include a second space 256. The body 20″ may include a third space 257. The second space 256 may be referred to as a groove 256.

The first space 255 may be formed between the insertion space 24 and the second space 256. The first space 255 may be positioned below the insertion space 24 to communicate with the insertion space 24. The first space 255 may be positioned above the second space 256 to communicate with the second space 256. The first space 255 may be positioned above the upper portion 2523 of the second cover portion 252 and the second space 256.

A lower portion 2522 of the second cover portion 252 may surround a lateral portion of the cover hole 254. The lateral portion 2521 of the second cover portion 252 may surround the lateral portion of the second space 256. The lower portion 2522 of the second cover portion 252 may be formed to protrude inward from the lower end of the lateral portion 2521 of the second cover portion 252.

The second space 256 may be formed between the cover hole 254 and the first space 255. The second space 256 may be opened up and down. The second space 256 may be positioned above the cover hole 254 to communicate with the cover hole 254. The second space 256 may be positioned below the first space 255 to communicate with the first space 255. The circumference of the second space 256 may be larger than the circumference of the cover hole 254.

The upper portion 2523 of the second cover portion 252 may be connected to the pipe 21. The upper portion 2523 of the second cover portion 252 may extend from the lower end of the pipe 21 to the upper end of the side portion 2522 of the second cover portion 252. The upper portion 2523 of the second cover portion 252 may extend in the circumferential direction along the inner circumferential surface of the pipe 21.

The third space 257 may be formed by opening the upper portion 2523 of the second cover portion 252. The third space 257 may be formed at an edge of the upper portion 2523 of the second cover portion 252 adjacent to the inner circumferential surface of the pipe 21. The third space 257 may be located below the first space 255 to communicate the first space 255 with the outside of the body 20″. The third space 257 may be provided in plurality. The plurality of third spaces 257 may be arranged to be spaced apart from each other in the circumferential direction. The third space 257 may be referred to as a slot 257.

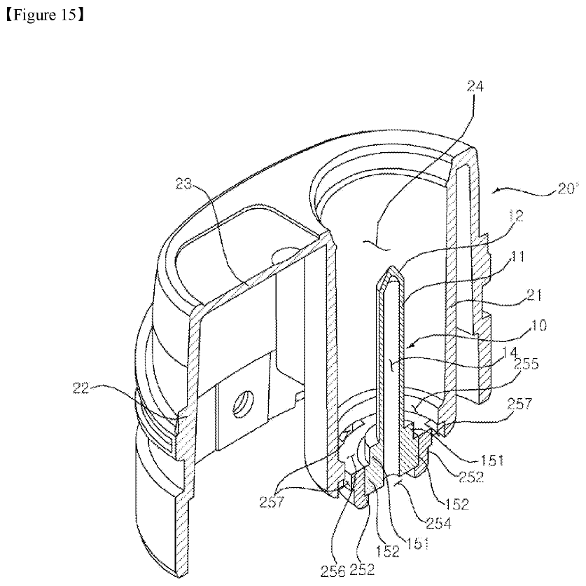

Referring to FIG. 14 and FIG. 15, the flanges 151, 152 may be inserted into the second space 256. The upper side of the heater pin 10 or the pin body 11 may be vertically disposed in the insertion space 24.

The second flange 152 may be inserted into the second space 256 and surrounded by the second cover portion 252. The second cover portion 252 may surround the lateral portion and the outer lower portion of the second flange 152. The cover hole 254 may communicate with the hollow 14 of the heater pin 10.

The first flange 151 may protrude upward of the second cover portion 252. The first flange 151 may protrude higher than the upper portion 2523 of the second cover portion 252. The first flange 151 may be disposed in the first space 255. The first space 255 may surround the first flange 151. The first flange 151 may be disposed below the insertion space 24.

The second space 256 and the second flange 252 may have shapes corresponding to each other. The shape of the second space 256 and the second flange 252 is non-circular, and may not rotate in the circumferential direction.

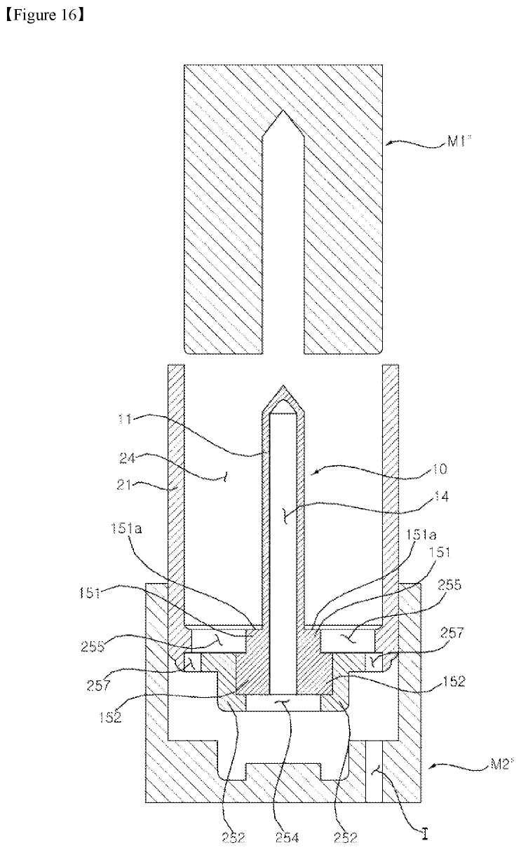

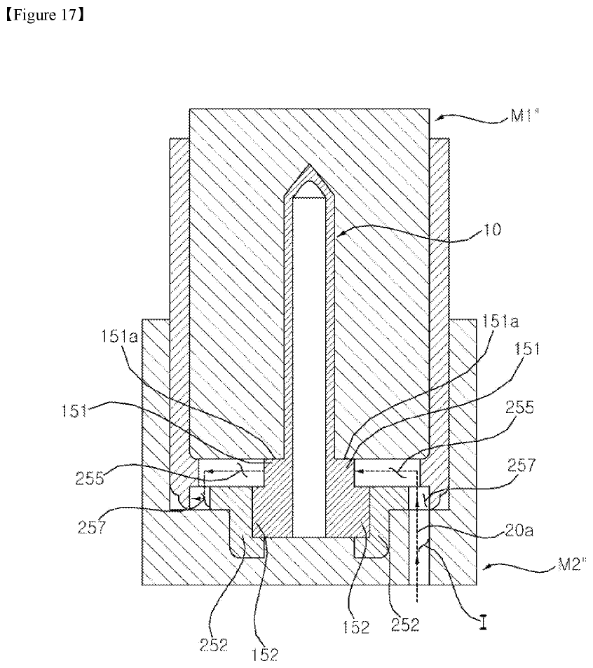

Referring to FIG. 16 and FIG. 17, the pin body 11 and the pin tip 12 may be inserted into the groove formed in the first mold M1″. The first mold M1″ may be inserted into the insertion space 24. The first mold M1″ may cover an upper portion of the first space 255.

The second cover portion 252 may be inserted into the second mold M2″. The second mold M2″ may surround the outside of the second cover portion 252 and be in close contact with each other. The second mold M2″ may be in close contact with the lower surface of the second flange 152. The second mold M2″ may cover the lower end of the third space 257.

The first space 255 may be positioned between the first mold M1″ and the second mold M2″. The third space 257 may be positioned between the first mold M1″ and the second mold M2″.

The injection hole I may be formed by opening any one of the first mold M1″ and the second mold M2″. The injection hole I may communicate with at least one of the first space 255 and the third space 257. For example, the injection hole I may be formed by opening the second mold M2″. For example, the injection hole I may communicate with the third space 257.

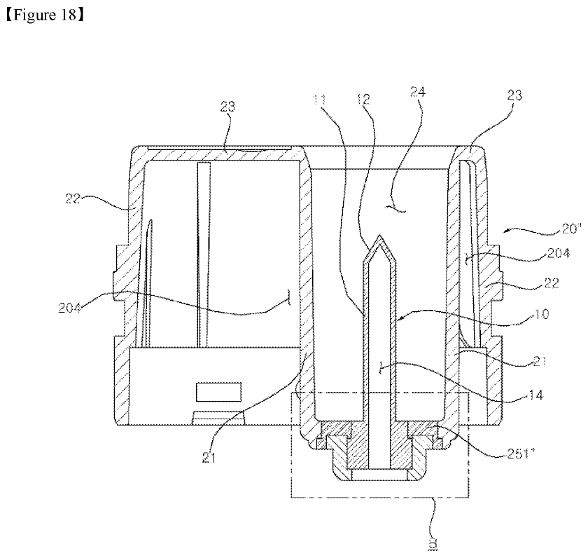

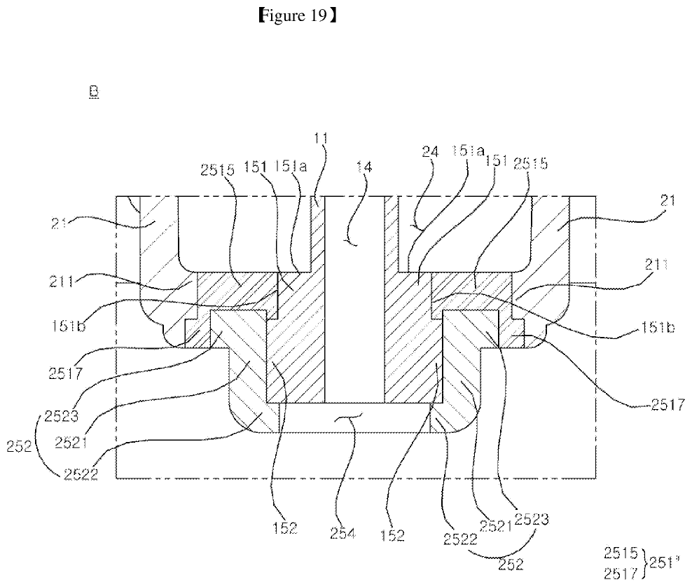

The injection-molding material 20a may be injected between the first mold M1″ and the second mold M2″ through the injection hole I. The injection-molding material 20a may be introduced into the first space 255 and the third space 257. The injection-molding material 20a may fill the first space 255 and the third space 257. The injection-molding material 20a filling the first space 255 and the third space 257 may be harden to form a first cover portion 251″ (refer to FIGS. 18 and 19). The injection-molding material 20a filling the first space 255 may be harden to form a first cover plate 2515 (refer to FIG. 19). The injection-molding material 20a filled with the third space 257 may be harden to form a first cover protrusion 2517 (refer to FIG. 19).

The first mold M1″ may be in close contact with the upper surface 151a of the first flange 151. Between the first mold M1″ and the upper surface 151a of the first flange 151, A gap communicating with the first space 255 may not be formed.

Accordingly, the injection-molding material 20a may not flow between the first mold M1″ and the upper surface 151a of the first flange 151. In addition, the injection-molding material 20a may not flow between the first mold M1 and the pin body 11.

Referring to FIG. 18 and FIG. 19, the first cover portion 251″ may include a first cover plate 2515. The first cover portion 251″ may include a first cover protrusion 2517.

The first cover portion 251″ may fill the first space 255 (refer to FIG. 17) and the third space 257 (refer to FIG. 17). 17) may be filled in. The first cover protrusion 2517 may fill the third space 257 (refer to FIG. 17) The first cover plate 2515 and the first cover protrusion 2517 may be integrally formed. The first cover protrusion 2517 may protrude from the first cover plate 2515.

The first cover plate 2515 may cover the lower portion of the insertion space 24 together with the upper surface 151a of the first flange 151. The first cover plate 2515 may have a disk shape. The upper surface of the first cover plate 2515 may be positioned in parallel with the upper surface 151a of the first flange 151 on the same plane.

The first cover plate 2515 may be coupled to the pipe 21, a lateral surface of the first flange 151, and an upper portion 2523 of the second cover portion 252. The first cover plate 2515 may be coupled to the lower end of the pipe 21. The first cover plate 2515 may be coupled to the lateral surface of the first flange 151 in close contact. The first cover plate 2515 may be coupled to cover the upper side of the upper portion 2523 of the second cover portion 252. The first cover plate 2515 may be coupled to cover the upper surface of the second flange 152.

The first cover protrusion 2517 may protrude from the edge of the first cover plate 2515. The first cover protrusion 2517 may be any one of the plurality of first cover protrusions 2517. The plurality of first cover protrusions 2517 may be arranged in a circumferential direction along an edge of the first cover plate 2515.

The first cover protrusion 2517 may be coupled to the lower end of the pipe 21. The first cover protrusion 2517 may be coupled to a lateral surface of the upper portion 2523 of the second cover portion 252. The first cover protrusions 2517 may be alternately disposed at the lower end of the pipe 21 in the vertical direction, and may be engaged with each other in the vertical direction. The first cover protrusion 2517 and the pipe 21 may have surfaces in contact with each other in the vertical direction. The first cover protrusion 2517 may be caught upward by the pipe 21.

The second flange 152 may be coupled between the first cover portion 251″ and the second cover portion 252. The second flange 152 may be vertically supported by the lower portion 2522 of the first cover portion 251″ and the first cover plate 2515.

Accordingly, it is possible to prevent the first cover portion 251″ from being separated or the heater pin 10 from being separated.

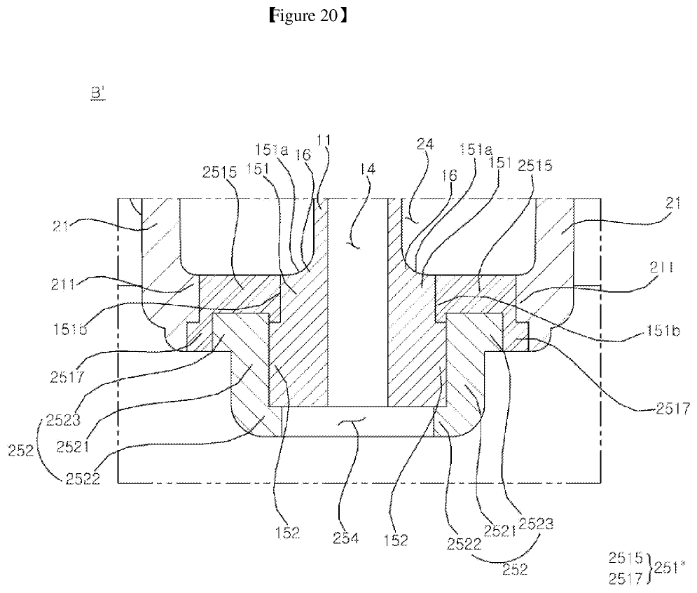

Referring to FIG. 20, the rib 16 may be formed between the pin body 11 and the upper surface 151a of the first flange 151. The rib 16 protrudes upwardly from the upper surface 151a of the first flange 151 and may extend obliquely upward toward the outer circumferential surface of the pin body 11. The rib 16 may be integrally formed with the pin body 11 and the first flange 151. The rib 16 may extend in the circumferential direction along the outer circumferential surface of the pin body 11. Alternatively, a plurality of ribs 16 arranged to be spaced apart from each other in the circumferential direction along the outer circumferential surface of the pin body 11.

Accordingly, the rib 16 can support the pin body 11 and can prevent the pin body 11 from being broken.

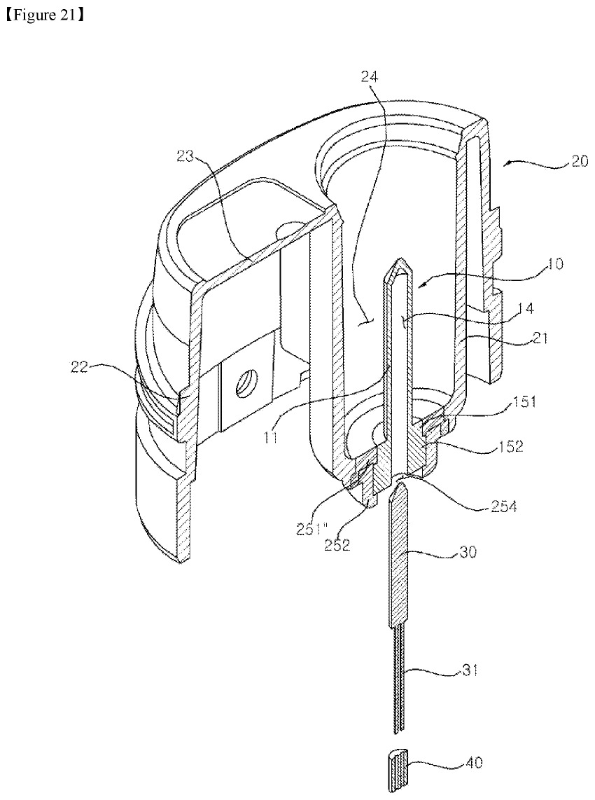

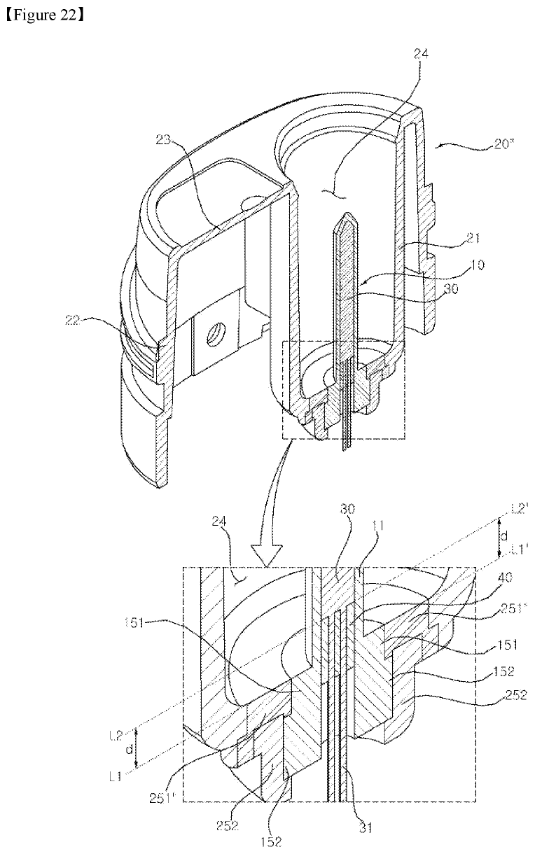

Referring to FIG. 21 and FIG. 22, the heater 30 may be inserted and fixed into the hollow 14 through the cover hole 254. The reinforcing material 40 may fill the hollow 14. The heater lead wire 31 may penetrate the hole of the reinforcing material 40 and be exposed to the outside of the heater pin 10. Hereinafter, as described above (refer to FIGS. 11 and 12).

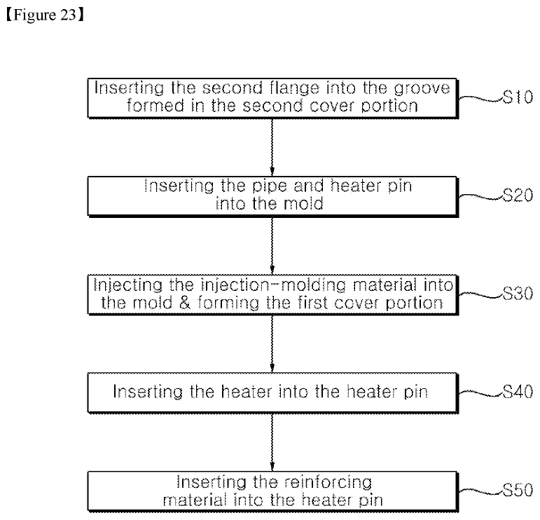

Referring to FIG. 23, the method for manufacturing an aerosol-generating device may include inserting the second flange 152 into the groove 256 formed in the second cover portion 252 (S10). In step S10, the second flange 152 may be inserted into the second space 256 to be surrounded and supported by the second cover portion 252. In step S10, the first flange 151 may protrude into the first space 255. In step S10, the pin body 11 may be disposed in the insertion space 24.

The method for manufacturing an aerosol-generating device may include a step (S20) of inserting the pipe 21 and the heater pin 10 into the molds M1″, M2″. In step S20, the first space 255 and the third space 257 may be positioned between the first mold M1″ and the second mold M2″. In step S20, the first mold M1″ may cover the upper portion of the first space 255. In step S20, the second mold M2″ may cover the lower portion of the third space 257.

The aerosol-generating device manufacturing method comprises the steps of injecting the injection-molding material 20a into the first space 255 and the third space 257 located in the molds M1″ and M2″ to form the first cover portion 251″ (S30). In step S30, the injection-molding material 20a may fill the second space 255 and the third space 257. The first cover portion 251″ formed in step S30 may be closely coupled to the lateral surface of the first flange 151. The cover portion 251″ formed in step S30 may be closely coupled to the upper surface of the second flange 152.

Accordingly, the first flange 151 and the second flange 152 may be supported in the vertical direction, and separation of the heater pin 10 may be prevented.

The method for manufacturing an aerosol-generating device may include inserting the heater 30 into the heater pin 10 (S3). In step S3, the heater 30 may be inserted into the hollow 14 in the heater pin 10. In step S3, the heater 30 may be disposed higher than the upper surface 151a of the first flange 151. Accordingly, the effect of the heat generated from the heater 30 on the first cover portion 251 “may be reduced.

The method for manufacturing an aerosol-generating device may include inserting the reinforcing material 40 into the heater pin 10 (S4). In step S4, the reinforcing material 40 may overlap and be fixed with the upper surface 151a of the first flange 151. In step S4, the reinforcing material 40 may reinforce the rigidity of the pin body 11 around the upper surface 151a of the first flange 151, inside the upper surface 151a of the first flange 151.

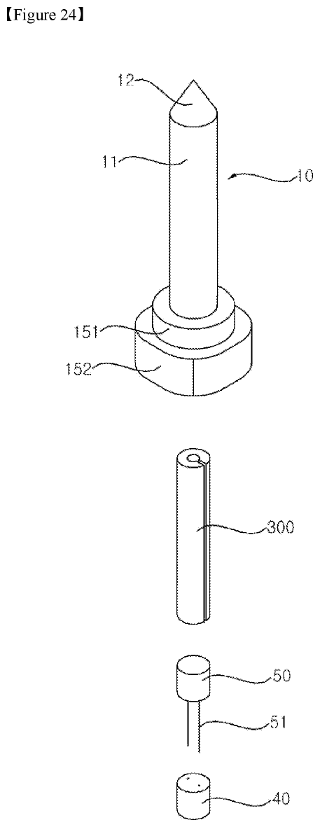

Referring to FIG. 24, the heater 300 may be inserted into the hollow 14 (refer to FIG. 2) of the heater pin 10. The heater 300 may be formed to be elongated in the vertical direction. The heater 300 is a magnetic material, and may be heated by an induced current. The heater 300 may have a shape in which a thin plate is rolled. the lead wire 31 connected to the heater 300 may be not existed (refer to FIG. 11).

The sensor 50 may be inserted into the hollow 14 (see FIG. 2). The sensor 50 may be disposed below the heater 300. The sensor 50 may sense the temperature of the heater 300. The sensor lead wire 51 may be connected to the sensor 50. The sensor lead wire 51 may be provided as a pair. The sensor lead wire 51 may transmit the power supplied from the power supply source to the sensor 50. The sensor lead wire 51 may transmit a control signal to the sensor 50.

The reinforcing material 40 may be inserted into the hollow 14 (refer to FIG. 2) of the heater pin 10. The reinforcing material 40 may be disposed below the sensor 50. The reinforcing material 40 may support the lower portion of the sensor 50. The reinforcing material 40 may be fixed in close contact with the inner circumferential surface of the heater pin 10 in the hollow 14. The reinforcing material 40 may fill the hollow 14. The sensor lead wire 51 may penetrate the reinforcing material 40 and be exposed to the outside of the heater pin 10.

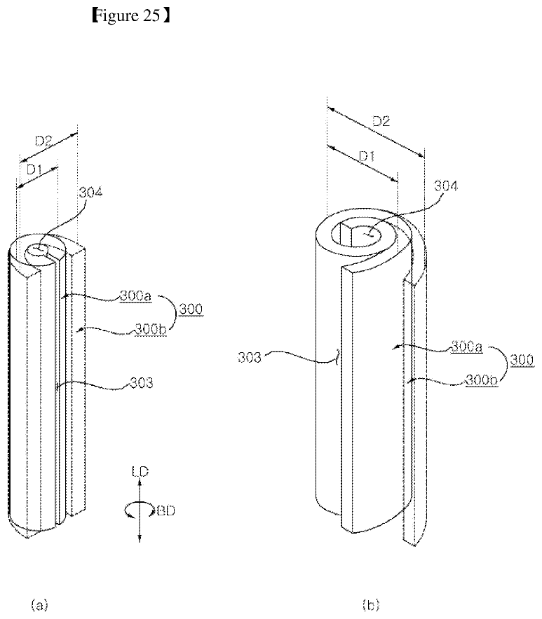

Referring to FIG. 25, the heater 300 may be vertically elongated. The heater 300 may have a cylindrical shape. The heater 300 may be flexible. The heater 300 may have a shape in which a thin plate is rolled into a cylindrical shape or is bent. The bending direction BD in which the heater 300 is bent may cross the longitudinal direction LD of the heater 300. For example, the bending direction BD of the heater 300 may be perpendicular to the longitudinal direction LD of the heater 300.

Referring to FIG. 25A, the heater 300 may be bent in the bending direction BD. One side of the heater 300 may be cut along the longitudinal direction LD of the heater 300. The heater 300 may have a cut-out gap 303 extending long in the longitudinal direction LD on one side of the cylindrical shape. The heater 300 may have a C-shaped cross-section. The heater hole 304 may be defined as a space formed inside the heater 300. The heater 300 may surround the lateral side of the heater hole 304. The heater hole 304 may extend vertically from the inside of the heater 300. The heater hole 304 may communicate with the cutout gap 303. The heater hole 304 may be opened up and down.

Referring to FIG. 25B, as another example, the heater 300 may have a cylindrical shape rolled in a circumferential direction. The heater 300 may have a spiral-shaped cross-section. Even in this case, the heater hole 304 may be formed inside the heater 300. Even in this case, there may be the cutout gap 303 extending long in the longitudinal direction LD on one side.

The curvature of the heater 300 in the second state 300b may be smaller than the curvature of the heater 300 in the first state 300a. The heater 300 in the second state 300b may have a greater radius of curvature than the heater in the first state 300a. In the heater 300 in the second state 300b, the heater hole 304 and the cutout gap 303 may be larger than the heater in the first state 300a.

The heater 300 may be formed of an elastic body. The heater 300 may have a property of restoring from the first state 300a in which the heater 300 is rolled to the second state 300b in which the heater 300 is unfolded by an elastic force to the outside. The heater 300 may have a restoring force or an elastic force in a direction in which the curvature decreases. The heater 300 may have a restoring force or an elastic force in a direction in which the radius of curvature or the radius of the heater 300 increases. The heater 300 may have a restoring force or an elastic force in a direction in which the size of the heater hole 304 and the cutout gap 303 increases.

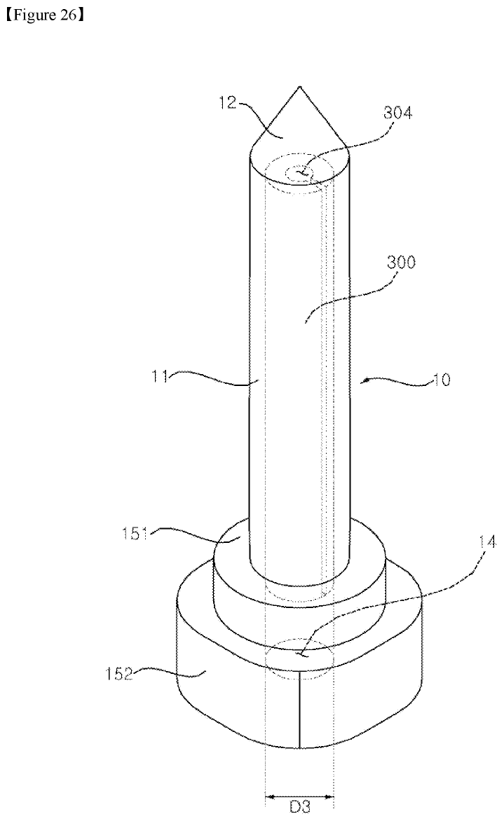

Referring to FIG. 25 and FIG. 26, the heater 300 in the first state 300a may be inserted into the hollow 14 of the heater pin 10. The diameter D1 of the outer peripheral surface of the heater 300 in the first state 300a may be smaller than the diameter D3 of the hollow 14. The diameter D2 of the outer circumferential surface of the heater 300 in the second state 300b may be greater than the diameter D3 of the hollow 14.

The heater 300 in the hollow 14 may have an elastic force or a restoring force from the first state 300a toward the second state 300b. The diameter D1 of the outer circumferential surface of the heater 300 in the hollow 14 may be equal to the diameter D2 of the hollow 14. The curvature of the outer circumferential surface of the heater 300 in the hollow 14 may be equal to the curvature of the hollow 14. In the hollow 14, the heater 300 pushes the inner circumferential surface of the heater pin 10 by an elastic force, and may press the inner circumferential surface of the heater pin 10.

Accordingly, the outer circumferential surface of the heater 300 may be fixed in close contact with the inner circumferential surface of the heater pin 10 in the hollow 14. In addition, a bonding operation for fixing the heater 300 to the inside of the heater pin 10 may be unnecessary, and there is no need for a lead wire for the heater 300, so the manufacturing process may be simplified. In addition, the problem of twisting or disconnection of the lead wire may not occur.

Referring to FIG. 13 and FIG. 23, in step S3, the heater 300 disclosed in FIGS. 25 and 26 may be inserted into the heater pin 10. Inserting the heater 300 (S3) may include bending the heater 300 to the first state 300a. Step S3 may include inserting the heater 300 in the first state 300a into the hollow 14 of the heater pin 10 through the opening. In step S3, the heater 300 may be inserted into the hollow 14 in a bent state of the first state 300a. In step S3, the heater 300 may be in close contact with the inner circumferential surface of the heater pin 10 in the hollow 14, and may be fixed to the inside of the heater pin 10. In step S3, the heaters 30, 300 may be disposed at a higher position than the cover portion 251.

Referring to FIG. 27, the induction coil 60 may be wound around the outer circumferential surface of the pipe 21 a plurality of times. The induction coil 60 may surround the periphery of the heater 300. The heater 300 may be heated in an induction heating method through the induction coil 60.

The heater 300 may be disposed above the bottom of the insertion space 24. The heater 300 may be disposed above the first cover portion 251. The heater 300 may be disposed above the first flange 151. The first line L1-L1′ may be defined as virtual line on the same plane as the bottom of the insertion space 24 or the top surface of the first cover portion 251. The second line L2-L2′ may be defined as virtual line which is parallel to the first line L1-L1′ and is on the same plane as the bottom of the heater 300. The second line L2-L2′ may be spaced upward from the first line L1-L1′ by a predetermined distance d. The predetermined distance d may be 0 mm or more.

Accordingly, the influence of the heat generated from the heater 300 on the first cover portion 251 may be reduced. In addition, it is possible to prevent the first cover portion 251 from being thermally deformed so that a gap is generated between the first cover portion 251 and the heater pin 10 or the gap is widened. In addition, it is possible to prevent foreign substances such as liquid from leaking through the gap.

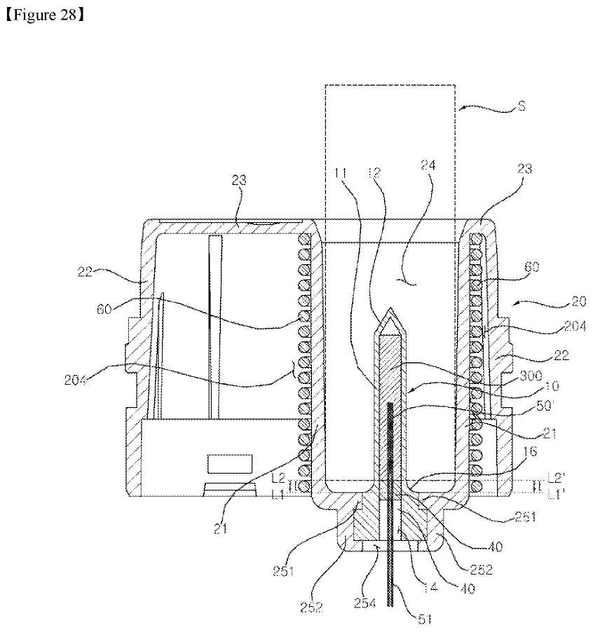

Referring to FIG. 28, the sensor 50′ may be inserted into the heater hole 304 (refer to FIG. 26). The sensor 50′ may have a shape corresponding to the heater hole 304. The sensor 50′ may be vertically elongated. For example, the sensor 50′ may have an elongated cylindrical shape. The sensor 50′ may be surrounded by the heater 300. The sensor 50′ may sense the temperature of the heater 300 inside the heater 300.

The sensor lead wire 51 may extend from the sensor 50′ to the lower side of the heater 300. The sensor lead wire 51 may extend below the second cover portion 252 through the reinforcing material 40.

The reinforcing material 40 may overlap the upper surface 151a of the first flange 151. The reinforcing material 40 may extend vertically. The upper end of the reinforcing material 40 may be located at a height higher than the upper surface 151a of the first flange 151. The lower end of the reinforcing material 40 may be located at a height lower than the upper surface 151a of the first flange 151. The reinforcing material 40 may reinforce the rigidity of the pin body 11 around the upper surface 151a of the first flange 151 on the inside of the upper surface 151a of the first flange 151.

Accordingly, the influence of the heat generated from the heater 30 on the first cover portion 251 may be reduced. In addition, it is possible to prevent the first cover portion 251 from being thermally deformed so that a gap is generated between the first cover portion 251 and the heater pin 10 or the gap is widened. In addition, it is possible to prevent foreign substances such as liquid from leaking through the gap.

In addition, the reinforcing material 40 may prevent the heater pin 10 from breaking around the first flange 151.

Referring to FIG. 1 to FIG. 28, an aerosol-generating device according to an aspect of the present disclosure may include an elongated heater pin; a flange protruding laterally from one side of the heater pin; a pipe shaped to define an insertion space; and a cover blocking one side of the insertion space and coupled to the flange such that the heater pin is protruded to the insertion space, wherein the flange may be coupled to engage with the cover and includes a surface that is exposed to the insertion space.

According to another aspect of the present disclosure, wherein the flange may be structured to include a plurality of outwardly protruding steps.

According to another aspect of the present disclosure, the flanges 151, 152 may include: wherein the flange comprises: a first flange protruding from the one side of the heater pin a first distance; and a second flange adjacent to the other side of the heater pin than the first flange, and protruding from the one side of the heater pin a second distance that is greater that the first distance, wherein the second flange is surrounded by the cover.

According to another aspect of the present disclosure, the cover 251, 252 may include a first cover portion coupled to a lateral portion of the first flange and an upper portion of the second flange, wherein the first cover portion covers the one side of the insertion space along with the first flange; and a second cover portion extending from the first cover portion and shaped to surround the second flange, wherein the second cover portion contacts the second flange.

According to another aspect of the present disclosure, the first cover portion, the second cover portion, and the pipe may be integrally formed.

According to another aspect of the present disclosure, the second cover portion and the pipe may be integrally formed, and the first cover portion may be formed integrally with the second cover portion and the pipe while forming a boundary therebetween.

According to another aspect of the present disclosure, the flanges 151, 152 may include: a first flange protruding from the one side of the heater pin; a second flange protruding from the one side of the heater pin; and a third flange positioned between the first flange and the second flange, wherein the third flange is recessed relative the protrusions of the first flange and the second flange.

According to another aspect of the present disclosure, the cover 251, 252 may include a first cover portion coupled to a lateral portion of the first flange and covering the one side of the insertion space along with the first flange; a second cover portion coupled to a lateral portion of the second flange; and a third cover portion positioned between the first cover portion and the second cover portion and protruding further inward relative to the first cover portion and the second cover portion, wherein the third cover portion is coupled to a lateral portion of the third flange.

According to another aspect of the present disclosure, the heater pin 10 may be shaped to define a hollow that is open to the other side of the heater pin, wherein the aerosol-generating device may further comprise a heater located in the hollow and configured to generate heat.

According to another aspect of the present disclosure, the aerosol-generating device may include a reinforcing material filling a portion of the hollow at a lower side of the heater and overlapping the first flange to support the heater pin adjacent to the first flange.

According to another aspect of the present disclosure, the second cover portion is shaped to define a cover hole that communicates with the opening of the hollow.

According to another aspect of the present disclosure, the aerosol-generating device may include a rib extending from the flange to an outer circumferential surface of the heater pin adjacent to the flange to support the heater pin.

According to another aspect of the present disclosure, the rib extends in a circumferential direction along a circumference of an outer circumferential surface of the heater pin.

According to another aspect of the present disclosure, at least one of the first flange or the second flange has a non-circular cross-section.

In addition, the method for manufacturing an aerosol-generating device according to an aspect of the present disclosure may include inserting the heater pin into a mold; and injecting an injection-molding material into the mold to form the pipe and the cover, wherein in the inserting the heater pin into the mold, the mold adjacent to the heater pin is in contact with an upper surface of the flange.

According to another aspect of the present disclosure, the method for manufacturing the aerosol-generating device may include inserting the heater pin into a mold; and injecting an injection-molding material into the mold to form the pipe and the cover, wherein in the inserting the heater pin into the mold, the mold adjacent to the heater pin is in contact with an upper surface of the flange.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An aerosol-generating device, comprising:
an elongated heater pin;
a flange protruding laterally from one side of the heater pin;
a pipe shaped to define an insertion space; and
a cover blocking one side of the insertion space and coupled to the flange such that the heater pin is protruded to the insertion space,
wherein the flange is coupled to engage with the cover and includes a surface that is exposed to the insertion space.

2. The aerosol-generating device according to claim 1, wherein the flange is structured to include a plurality of outwardly protruding steps.

3. The aerosol-generating device according to claim 2, wherein the flange comprises:
a first flange protruding from the one side of the heater pin a first distance; and
a second flange adjacent to the other side of the heater pin than the first flange, and protruding from the one side of the heater pin a second distance that is greater that the first distance, wherein the second flange is surrounded by the cover.

4. The aerosol-generating device according to claim 3, wherein the cover comprises:
a first cover portion coupled to a lateral portion of the first flange and an upper portion of the second flange, wherein the first cover portion covers the one side of the insertion space along with the first flange; and
a second cover portion extending from the first cover portion and shaped to surround the second flange, wherein the second cover portion contacts the second flange.

5. The aerosol-generating device according to claim 4, wherein the first cover portion, the second cover portion, and the pipe are integrally formed.

6. The aerosol-generating device according to claim 4, wherein the second cover portion and the pipe are integrally formed, and
the first cover portion is formed integrally with the second cover portion and the pipe while forming a boundary therebetween.

7. The aerosol-generating device according to claim 2, wherein the flange comprises:
a first flange protruding from the one side of the heater pin;
a second flange protruding from the one side of the heater pin; and
a third flange positioned between the first flange and the second flange, wherein the third flange is recessed relative the protrusions of the first flange and the second flange.

8. The aerosol-generating device according to claim 7, wherein the cover comprises:
a first cover portion coupled to a lateral portion of the first flange and covering the one side of the insertion space along with the first flange;
a second cover portion coupled to a lateral portion of the second flange; and
a third cover portion positioned between the first cover portion and the second cover portion and protruding further inward relative to the first cover portion and the second cover portion, wherein the third cover portion is coupled to a lateral portion of the third flange.

9. The aerosol-generating device according to claim 7, wherein the heater pin is shaped to define a hollow that is open to the other side of the heater pin,
wherein the aerosol-generating device further comprises a heater located in the hollow and configured to generate heat.

10. The aerosol-generating device according to claim 9, further comprising a reinforcing material filling a portion of the hollow at a lower side of the heater and overlapping the first flange to support the heater pin adjacent to the first flange.

11. The aerosol generating device of claim 9, wherein the second cover portion is shaped to define a cover hole that communicates with the opening of the hollow.

12. The aerosol generating device according to claim 9, further comprising a rib extending from the flange to an outer circumferential surface of the heater pin adjacent to the flange to support the heater pin.

13. The aerosol generating device according to claim 12, wherein the rib extends in a circumferential direction along a circumference of an outer circumferential surface of the heater pin.

14. The aerosol generating device according to claim 3, wherein at least one of the first flange or the second flange has a non-circular cross-section.

15. A method of manufacturing the aerosol generating device of claim 1, the method comprising:
inserting the heater pin into a mold; and
injecting an injection-molding material into the mold to form the pipe and the cover,
wherein in the inserting the heater pin into the mold, the mold adjacent to the heater pin is in contact with an upper surface of the flange.

16. A method of manufacturing the aerosol generating device of claim 6, the method comprising:
inserting the second flange into a groove formed in the second cover portion;
inserting the pipe and the heater pin into a mold; and
injecting an injection-molding material into the mold to form the first cover portion,
wherein in the inserting the second flange into the groove formed in the second cover portion, the first flange protrudes from the groove toward the insertion space, and
wherein in the inserting the pipe and the heater pin into the mold, the mold adjacent to the heater pin is in contact with the upper surface of the first flange.
